(19) United States
(12) Patent Application Publication
(10) Pub. No.: US 2026/0217197 A1
(43) Pub. Date: Jul. 30, 2026

(54) VEHICLE HANGER ASSEMBLY

(71) Applicant: NISSAN NORTH AMERICA, INC., Franklin, TN (US)

(72) Inventor: Jose Luis PEREZ BONILLA, Lerma (MX)

(21) Appl. No.: 19/039,211

(22) Filed: Jan. 28, 2025

(51) Int. Cl. B60R 7/08; B60N 2/879

(52) U.S. Cl. CPC B60R 7/08; B60N 2/879; B60N 2/90; B60N 2002/905

(57) ABSTRACT

A vehicle hanger assembly includes a main body and an arm. The main body is configured to be connected to a headrest. The arm is movably connected to the main body. The arm is configured to move relative to the main body to reduce a length of the vehicle hanger assembly in a lateral direction of a vehicle.

### BACKGROUND

### Technical Field

The present disclosure generally relates to a hanger assembly for a vehicle. More specifically, the present disclosure relates to a vehicle hanger assembly in which an arm of the hanger assembly moves relative to a main body of the hanger assembly.

### Background Information

Existing hanger accessories for vehicles are not adjustable to accommodate changing situations within the vehicle, such as a passenger desiring a different configuration of the hanger accessory. Additionally, a hanger accessory used within the vehicle can negatively impact deployment of an air bag.

### SUMMARY

A need exists for an improved hanger assembly for a vehicle.

In view of the state of the known technology, one aspect of the present disclosure is to provide a vehicle hanger assembly. The vehicle hanger assembly includes a main body and an arm. The main body is configured to be connected to a headrest. The arm is movably connected to the main body. The arm is configured to move relative to the main body to reduce a length of the vehicle hanger assembly in a lateral direction of a vehicle.

Also other objects, features, aspects and advantages of the disclosed vehicle hanger assembly and method will become apparent to those skilled in the art from the following detailed description, which, taken in conjunction with the annexed drawings, discloses exemplary embodiments of the vehicle hanger assembly and method.

### BRIEF DESCRIPTION OF THE DRAWINGS

Referring now to the attached drawings which form a part of this original disclosure:

FIG. 1 is a side elevational of a vehicle hanger assembly in accordance with an exemplary embodiment;

FIG. 2 is a bottom plan view of the vehicle hanger assembly of FIG. 1;

FIG. 3 is a rear elevational view of the vehicle hanger assembly of FIG. 1;

FIG. 4 is a side elevational view in cross section of a main body and an arm of the vehicle hanger assembly of FIG. 1 in which the arm is in a first position;

FIG. 5 is a side elevational view of the arm of FIG. 4;

FIG. 6 is an exploded assembly view of the main body of FIG. 4;

FIG. 7 is a perspective view of the arm of FIG. 4;

FIG. 8 is a side elevational view in cross section of the main body of FIG. 4 in which a second spring member is compressed;

FIG. 9 is a side elevational view in cross section of the main body and the arm of the vehicle hanger assembly of FIG. 1 in which the arm is in a second position;

FIG. 10 is a side elevational view in cross section of the main body and the arm of FIGS. 8 and 9 in which the arm is disposed in a second position;

FIG. 11 is a side elevational view in cross section of a vehicle hanger assembly in accordance with another exemplary embodiment in which an arm is disposed in a first position;

FIG. 12 is a side elevational view in cross section of the vehicle hanger assembly of FIG. 11 in which the arm is disposed in a second position;

FIG. 13 is a side elevational view of a vehicle hanger assembly in accordance with another exemplary embodiment in which an arm is disposed in a first position;

FIG. 14 is a side elevational view in cross section of the vehicle hanger assembly of FIG. 13 in which the arm is disposed in a second position;

FIG. 15 is a top plan view of an end surface of a main body of the vehicle hanger assembly of FIG. 13; and

FIG. 16 is a side elevational view of an arm of the vehicle hanger assembly of FIG. 13.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

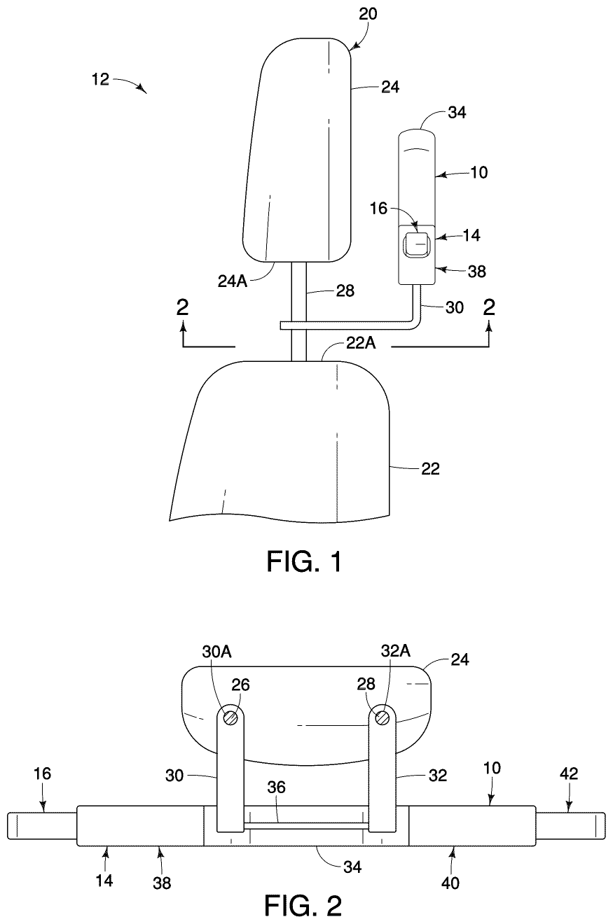

Referring initially to FIGS. 1-10, a hanger assembly 10 for a vehicle 12 is illustrated in accordance with an exemplary embodiment. The vehicle hanger assembly 10 includes a main body 14 and an arm 16. The main body 14 is configured to be removably connected to a headrest 24. The arm 16 is movably connected to the main body 14. The arm 16 is configured to move relative to the main body 14 to reduce a length of the vehicle hanger assembly 10 in a lateral direction D of a vehicle 12. The main body 14 and the arm 16 of the vehicle hanger assembly 10 can be made of any suitable material, such as a plastic.

The vehicle 12 includes a seat 20, as shown in FIGS. 1-3. The seat 20 includes a seatback 22 and a headrest 24. The seat 20 is connected to a floor of a passenger compartment of the vehicle 12 in a conventional manner. The seatback 22 and the headrest 24 are connected to one another in a conventional manner. The seat 20 can be any seat of a vehicle having a headrest to which the vehicle hanger assembly 10 can be connected. The vehicle 12 can be any vehicle in which the vehicle seat 20 can be disposed, such that the vehicle, the vehicle floor, and the passenger compartment are not discussed or illustrated herein. Additionally, conventional parts of the vehicle seat are not discussed or illustrated in detail herein.

The headrest 24 is connected to the seatback 22 of the seat 20 by at least one headrest support, or stay, 26, as shown in FIGS. 1-3. The headrest 24 is shown having first and second headrest supports 26 and 28 to connect the headrest 24 to the seatback 22 of the seat 20. The seatback 22 preferably includes conventional adjustment mechanisms that allow each of the headrest supports 26 and 28 to be moved relative to the seatback 22 to control a distance between a lower end 24A of the headrest 24 and an upper end 22A of the seatback 22. The adjustment mechanisms can lock each of the headrest supports 26 and 28 at a desired position. The adjustment mechanisms allow the headrest supports 26 and 28 to be removed from the seatback 22 such that the hanger assembly 10 can be connected thereto, as shown in FIGS. 1-3.

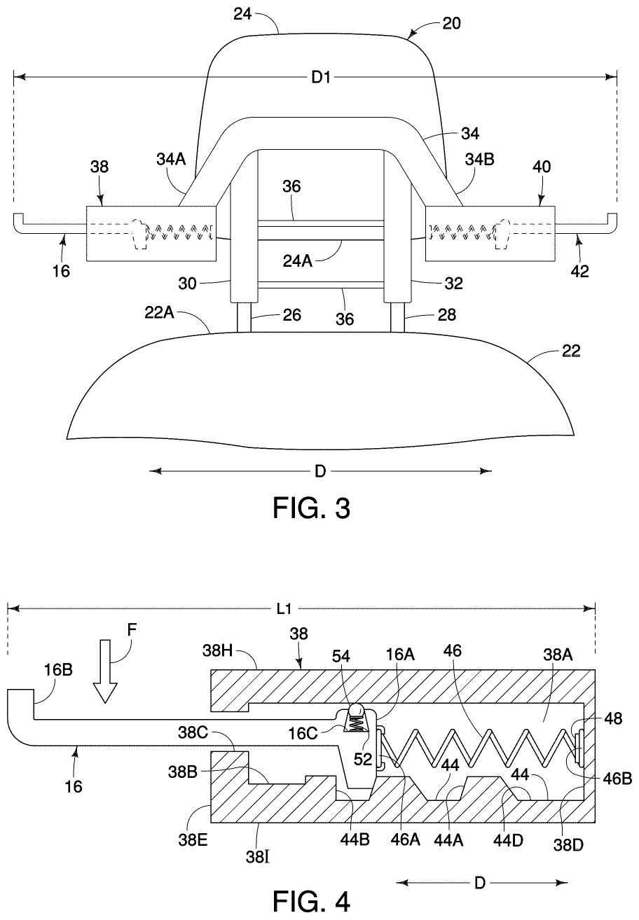

The hanger assembly 10 includes at least one support arm 30 configured to be connected to the at least one headrest support 26 of the seat 22, as shown in FIGS. 1-3. The hanger assembly 10 preferably includes a support arm 30 for each of the headrest supports 26 of the seat 20. As shown in FIGS. 2-3, the seat 20 includes first and second headrest supports 26 and 28, and the hanger assembly 10 includes a first support arm 30 and a second support 32. The first support arm 30 includes an opening 30A configured to receive the first headrest support 26. The second support arm 32 includes an opening 32A configured to receive the second headrest support 26. The first and second support arms 30 and 32 receive the first and second headrest supports 26 and 28 in any suitable manner, such as by an interference fit. The first and second support arms 30 and 32 are rigidly connected to the first and second headrest supports 26 and 28 such that the main body 14 of the hanger assembly 10 is substantially prevented from movement with respect to the headrest supports 26 and 28.

Each of the first and second support arms 30 and 32 is preferably substantially L-shaped, as shown in FIG. 1. Each of the first and second support arms 30 and 32 has a first end connected to one of the headrest supports 26 and 28 and a second end connected to a support member 34 of the main body 14 of the hanger assembly 10. A plurality of strengthening members 36 extend between the first and second support arms 30 and 32. The first and second support arms 30 and 32 provide a removable connection with the headrest supports 26 and 28 of the headrest 24 of the seat 20.

A first chamber 38 is disposed at a first end 34A of the support member 34, and a second chamber 40 is disposed at a second end 34B of the support member 34, as shown in FIGS. 2 and 3. The first and second chambers 38 and 40 can be integrally formed as a one-piece member with the support member 34. Alternatively, the first and second chambers 38 and 40 can be connected to the support member 34 in any suitable manner, such as with an adhesive or fasteners.

A first arm 16 is movably connected to the first chamber 38 of the main body 14 of the hanger assembly 10. A second arm 42 is movably connected to the second chamber 40 of the main body 14 of the hanger assembly 10. Each of the first and second arms 16 and 42 is configured to independently move relative to the first and second chambers 38 and 40 of the main body 14 to reduce a length of the vehicle hanger assembly 10 in the lateral direction D of the vehicle 12. The second chamber 40 and the second arm 42 are configured substantially similarly to the first chamber 38 and the first arm 16 such that descriptions thereof are omitted.

The first chamber 38 movably receives the first arm 16, as shown in FIGS. 1-4 and 8-10. The chamber 38 defines a cavity 38A within which the arm 16 is configured to move in the lateral direction D of the vehicle. A plurality of notches 44 are formed in a lower, inner surface 38B of the first chamber 38. The notches 44 are configured to receive the first arm 16, as shown in FIGS. 4, 8 and 9. Each of the plurality of notches 44 is spaced apart in the lateral direction D of the vehicle.

A surface 44A of the notch 44 that is adjacent to another notch is slanted to facilitate the first arm 16 moving between notches 44. An end surface 44B of the notch that is not adjacent another notch is substantially perpendicular to the lower surface 38B to substantially prevent further movement in that direction. As shown in FIG. 4, the left-side wall 44B of the first notch 44C is substantially perpendicular to the lower surface 38B to prevent movement of the first arm 16 to the left from the first notch 44. The end wall 38D is substantially perpendicular to the lower, inner surface 38B to prevent further movement of the first arm 16 to the right from the last notch. The middle notch 44 has slanted walls at both ends to facilitate movement of the first arm 16 to either the left or the right from the middle notch.

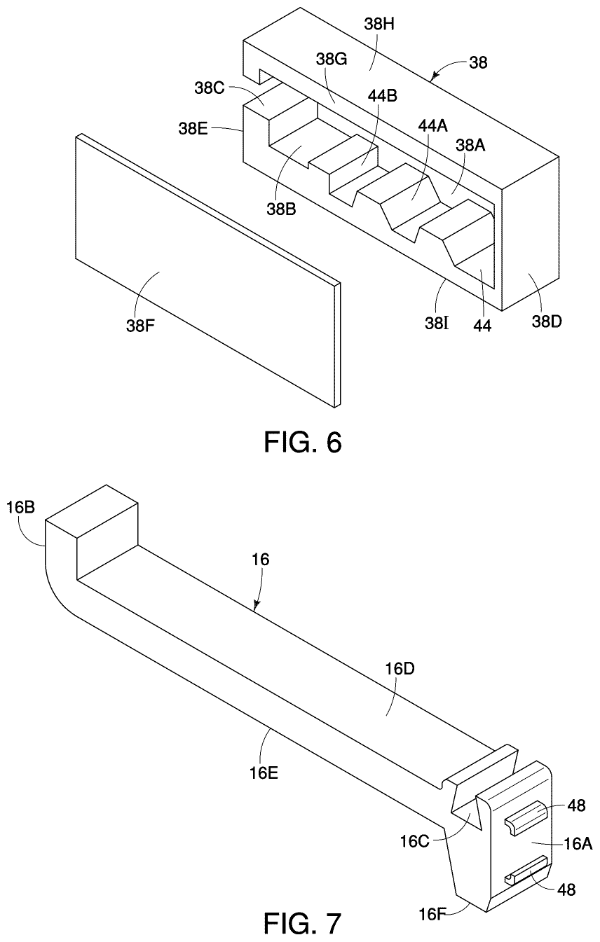

As shown in FIGS. 4 and 6, the first chamber 38 includes an opening 38C disposed in a front wall 38E of the first chamber 38. The opening 38C has a substantially rectangular shape. The opening 38C is configured to provide access to the cavity 38A of the first chamber 38.

As shown in FIG. 6, the first chamber 38 includes a side wall 38F that is connected to an open side 38G of the first chamber 38 to enclose the cavity 38A along the side of the first chamber 38. The side wall 38F is connected to the open side 38G of the first chamber 38 in any suitable manner, such as with an adhesive or a fastener. The side wall 38F is a substantially planar member extending from the front wall 38E to the end wall 38D, and from an upper wall 38H to a lower wall 38I.

The rear wall 38D defines a first end of the first chamber 38, and the front wall 38E defines a second end of the first chamber 38. The opening 38C is disposed in the second end of the first chamber 38.

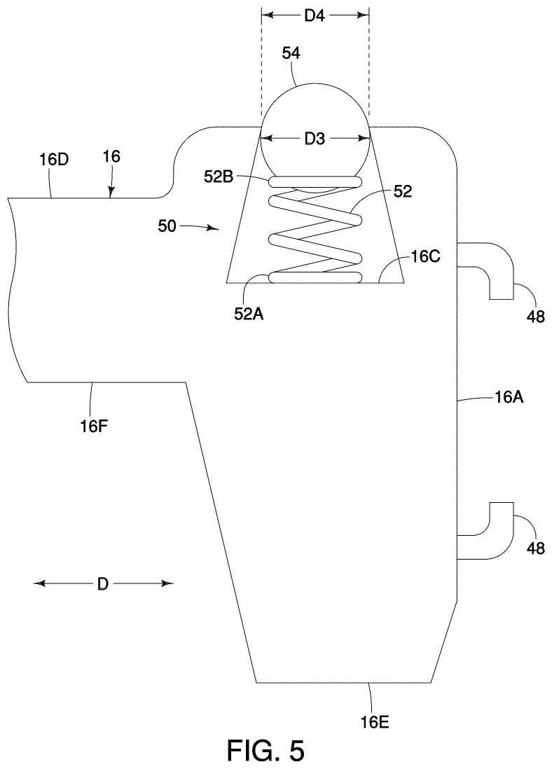

The first arm 16 extends from a first end 16A to a second end 16B, as shown in FIGS. 4, 5 and 7-9. The first end 16A of the first arm 16 is disposed within the cavity 38A of the first chamber 38, as shown in FIG. 4. The second end 16B of the first arm 16 is disposed externally of the cavity 38A of the first chamber 38. A groove 16C is disposed in an upper surface 16D of the first arm 16. The groove 16C is preferably disposed proximate the first end 16A of the first arm 16. A projection 16E extends downwardly from a lower surface 16E of the first arm 16, as shown in FIGS. 5 and 7. The projection 16E is preferably disposed at the first end 16A of the first arm 16. The projection 16E of the first arm 16 is configured to engage one of the plurality of notches 44 in the inner, lower surface 38B of the first chamber 38. The groove 16C is preferably disposed above the projection 16E, as shown in FIG. 5.

A first spring member 46 is disposed between a first end 16A of the first arm 16 and the first end of the first chamber 38, as shown in FIGS. 3, 4 and 8-10. Preferably, the first spring member 46 does not overlap any portion of the first arm 16 when viewed in a direction perpendicular to the lateral direction of the vehicle. A first end 46A of the first spring member 46 is connected to the first end 16A of the first arm 16. As shown in FIGS. 5 and 7, a first retention member 48 is connected to the first end 16A of the first arm to securely retain the first spring member 46 to the first arm 16. Alternatively, the first spring member 46 can be connected to the first end of the first spring member 46 in any suitable manner, such as with an adhesive. A second end 46B of the first spring member 46 is connected to an inner surface of the rear wall 38G, or the first end, of the first chamber 38. A second retention member 48 is connected to the inner surface of the rear wall 38G of the first chamber 38 to securely retain the first spring member 46 to the first chamber 38. Alternatively, the second retention member 48 can be connected to the first chamber 36 in any suitable manner, such as with an adhesive.

As shown in FIG. 5, a locking member 50 is movably received by the first arm 16. The locking member 50 substantially prevents the first arm 16 from disengaging the one of the plurality of notches 44 in the cavity 38A of the first chamber 38.

The locking member 50 includes a second spring member 52 and a ball 54, as shown in FIG. 5. A first end 52A of the second spring member 52 is connected to a lower surface of the groove 16C. The first end 52A of the second spring member 52 is connected to the lower surface of the groove 16C in any suitable manner, such as with an adhesive. The ball 54 is connected to a second end 52B of the second spring member 52. The ball 54 is connected to the second end 52B of the second spring member 52 in any suitable manner. As shown in FIG. 4, the second spring member 52 biases the ball 54 to the inner surface of the upper wall 38H.

A diameter D3 of the ball 54 is larger than a length D4 of the groove 16C in the lateral direction D, as shown in FIG. 5. The length D4 of the groove 16C is measured at the upper surface 16D of the first arm 16. The length D4 being smaller than the diameter D3 of the ball 54 prevents the ball 54 from passing out of the groove 16C. In other words, the ball 54 is received in the groove 16C of the first arm 16.

To movably connect the first arm 16 to the first chamber 38, the first arm 16 is disposed such that the first end 16A is disposed in the cavity 38A and the second end 16B is disposed externally of the first chamber 38, as shown in FIGS. 4 and 6, prior to connecting the side wall 38E to the open side 38F of the first chamber 38. The first arm 16 extends through the opening 38C in the first chamber 38 such that the first end 16A of the first arm 16 is disposed in the cavity 38A and the second end 16B of the first arm 16 is disposed externally of the first chamber 38. The side wall 38E is then connected to the open side 38F of the chamber 38 to close the cavity 38A and to prevent removal of the first arm 16 from the first chamber 38.

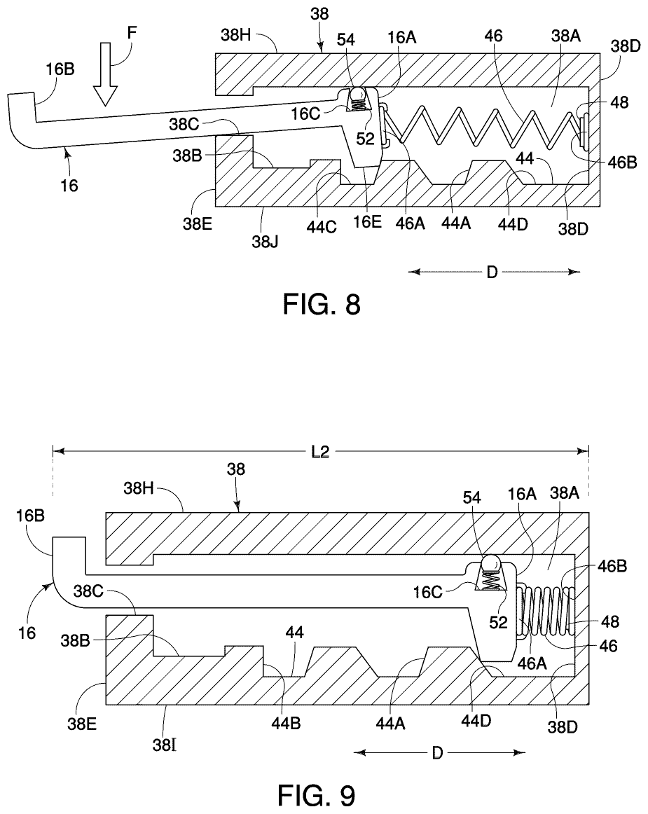

The locking member 50 biases the projection 16E of the first arm 16 into engagement with one of the notches 44 of the first chamber 38, as shown in FIG. 4. In other words, the second spring member 52 biases the ball 54 toward the upper surface, or the inner surface of the upper wall 38H, of the first chamber 38, thereby pushing the projection 16E of the first arm into engagement with one of the notches 44 of the first chamber 4. The first spring member 46 biases the first arm 16 in the inboard direction away from the opening 38C. Downward movement of the second end 16B of the first arm 16, such as with a force F, compresses the second spring member 52 to allow lateral movement of the first arm 16 to another one of the plurality of notches 44. Applying the downward force F to the second end 16B of the first arm 16 causes the first arm 16 to pivot about a contact point of the opening 38C in the front wall 38E. The pivotal movement of the first arm 16 causes the first end 16A of the first arm 16 to move upwardly toward the upper wall 38H of the chamber 38. The upward movement of the first end 16A of the first arm 16 compresses the second spring member 52. In other words, the force generated between the ball 54 and the inner surface of the upper wall 38H as the first end 16A of the first arm 16 moves upwardly compresses the second spring member 52. Compression of the second spring member 52 allows the projection 16E of the first arm 16 to move upwardly and out of the notch 44 in which the projection 16E was previously engaged. Once the projection 16E has moved above the walls defining the notch 44, the first arm 16 is configured to move in the lateral direction D of the vehicle to another one of the notches 44. When the downward force F applied to the first arm 16 is from an object, such as a deploying airbag, the first spring member 46 causes the projection to move from the first notch 44C to the second notch 44D, as shown in FIGS. 8-10, thereby shortening the distance from L1 to L2 and substantially preventing interference with deployment of the airbag.

As shown in FIGS. 3 and 8, the projection 16E of the first arm 16 is disposed in the first notch 44C, or the outboard-most notch, of the first chamber 38. When the projection 16E is disposed in the first notch 44C of the first chamber 38 and the projection of the second arm 42 is disposed in the first notch, or the outboard-most notch, of the second chamber 40, the vehicle hanger assembly has a first overall width D1. In other words, the first arm 16 is disposed in the first position, as shown in FIGS. 3 and 4. The overall width of the hanger assembly D1 is defined by a distance from an outermost end of the first arm 16 to an outermost end of the second arm 42. When both the first arm 16 and the second arm 42 are disposed in the outboard-most notches, the distance D1 is a maximum length of the hanger assembly 10. A distance L1 is defined between an outermost end of the first arm 16 to the rear wall 38D, as shown in FIG. 8, when the projection 16E is disposed in the first notch 44C.

The downward force F, as shown in FIGS. 4, 8 and 9, is applied to the first arm 16 to move the projection 16E from one notch 44 to another one of the notches 44. The downward force F is preferably applied at an outboard-most end of the first arm 16. As shown in FIG. 8, the projection 16E is disposed in the first notch 44C of the plurality of notches 44. When the projection 16E engages the first notch 44C, which is an outboard-most notch of the plurality of notches 44, the first arm 16 is in a first, or extended, position, providing a maximum length of the hanger assembly 10 when both the first and second arms 16 and 42 are disposed in the outboard-most notches. The downward force F applied to the first arm 16, causes upward movement of the first end 16A of the first arm 16, thereby compressing the second spring member 52 as the ball 54 contacts the inner surface of the upper wall 38H. When the second spring member 52 has compressed sufficiently such that the projection 16E has cleared the walls defining the notches 44, the first arm 16 can be moved in the lateral direction D of the vehicle 12. Preferably, the first wall 44B of the first notch 44A is high enough that the first arm 16 cannot be moved in an outboard direction beyond the first notch 44A. In other words, the first arm 16 cannot be moved closer to the opening 38C than the first notch 44C.

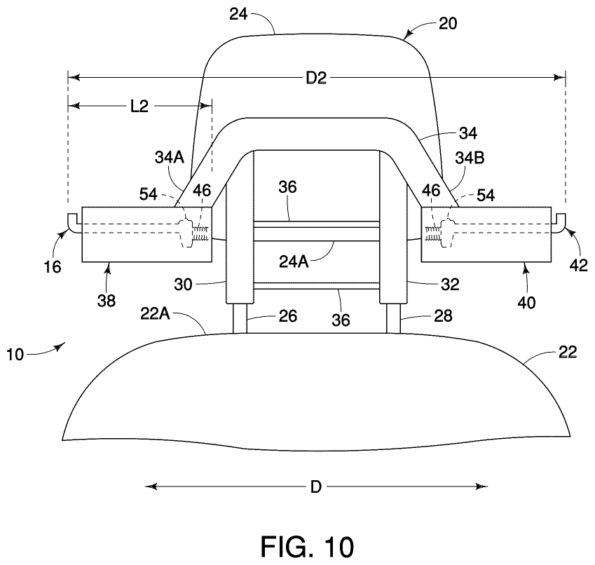

As shown in FIGS. 9 and 10, the first arm 16 is moved laterally away from the opening 38C such that the projection 16E engages the third notch 44D, or the inboard-most notch of the plurality of notches 44. In other words, the first arm 16 is disposed in a second position, as shown in FIGS. 9 and 10. The second position is a different position than the first position. When the first arm 16 engages the inboard-most notch 44D, the first arm is in a second, or a retracted, position, providing a minimum length of the hanger assembly 10 when both the first and second arms 16 and 42 engage the inboard-most notches. The inner surface of the rear wall 38D prevents lateral movement of the first arm 16 in a direction away from the opening 38C beyond the inboard-most notch, or the third notch 44D as shown in FIGS. 8 and 9.

As shown in FIGS. 9 and 10, the projection 16E of the first arm 16 is disposed in the third notch 44D, or the inboard-most notch, of the first chamber 38. When the projection 16E is disposed in the third notch 44D of the first chamber 38 and the projection of the second arm 42 is disposed in the third notch, or the inboard-most notch, of the second chamber 40, the vehicle hanger assembly has a second overall width D2. The overall width of the hanger assembly D2 is defined by a distance from an outboard-most end of the first arm 16 to an outermost end of the second arm 42. The distance D2 is less than the distance D1. When both the first arm 16 and the second arm 42 are disposed in the inboard-most notches, the distance D2 is a minimum length of the hanger assembly 10. A distance L2 is defined between an outermost end of the first arm 16 to the rear wall 38D, as shown in FIGS. 9 and 10, when the projection 16E is disposed in the third notch 44C. The distance L2 is less than the distance L1. Each of the first arm 16 and the second arm 42 is independently movable such that the hanger assembly 10 can have a plurality of lengths between D2 and D1, inclusive, based on the notches 44 engaged by the first and second arms 16 and 42, respectively.

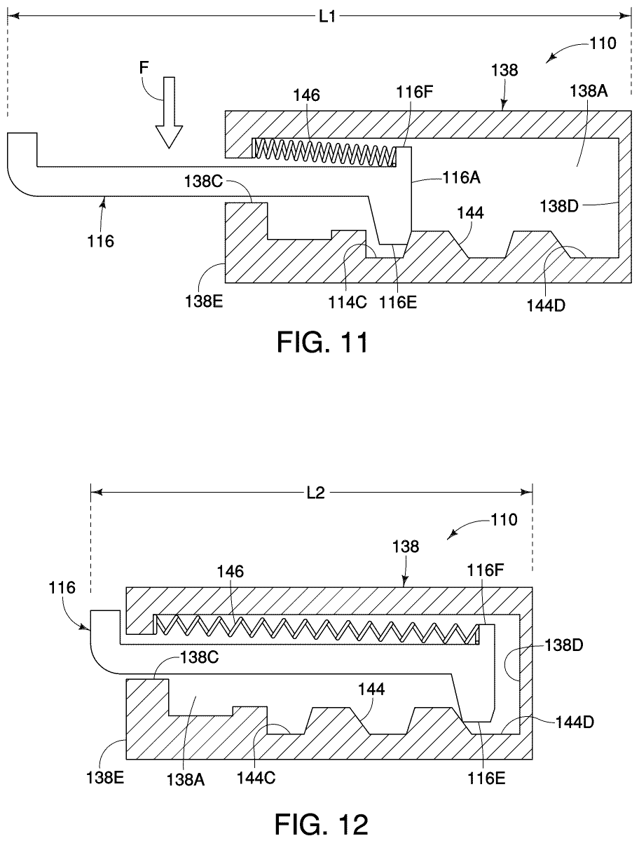

Another exemplary embodiment of the vehicle hanger assembly 110 is shown in FIGS. 11-12. The features of the vehicle hanger assembly 110 of FIGS. 11-12 that are substantially similar to the features of the vehicle hanger assembly 10 of FIGS. 1-10 are provided the same reference numerals as the features of the vehicle hanger assembly 10 except in the 100 series (i.e., 1xx). Moreover, the descriptions of the parts of the vehicle hanger assembly 110 of FIGS. 11-12 that are identical to the baby changing table assembly 10 of FIGS. 1-10 are omitted for the sake of brevity.

The vehicle hanger assembly 110 includes the first arm 116 configured to be laterally movable within the cavity 138A of the first chamber 138, as shown in FIGS. 11-12. The first arm includes an upwardly extending tab 116F disposed at the first end 116A of the first arm 116. The first spring member 146 extends between the tab 116F and an inner surface of the front wall 138E of the chamber 138. In other words, the first spring member 146 extends between the tab 116F of the arm 116 and the wall of the chamber 138 in which the opening 138C is disposed. The first spring member 146 biases the first arm 116 toward the opening 138C of the chamber 138. The spring member 146 is disposed above an upper surface of the arm 116. Preferably, an entirety of the spring member 146 is disposed above the upper surface of the arm 116.

As shown in FIG. 11, the first arm 116 is disposed in the first notch 144C, or the outboard-most notch, of the plurality of notches 144. In other words, the first arm 116 is disposed in a first position. When the projection 116E of the first arm 116 is disposed in the first notch 144C, the length L1 is a maximum distance from an outboard-most end of the first arm to the rear wall 138D of the chamber 138.

Applying a downward force F to the first arm 116, pivots the first arm 116 to raise the projection above the first notch 144D. The first arm 116 can then be moved laterally by applying a force larger than the compression force of the first spring member 146. As shown in FIG. 12, the first arm 116 is moved laterally to the third notch 144D. In other words, the first arm 116 is disposed in a second position. When the projection 116E of the first arm 116 is disposed in the third notch 144D, the length L2 is a minimum distance from an outboard-most end of the first arm to the rear wall 138D of the chamber 138. The distance L2 is less than the distance L1.

When the downward force F applied to the first arm 116 is from an object, such as a deploying airbag, the first spring member 146 causes the projection 116E to move from the first notch 144C to the second notch 144D, as shown in FIGS. 11-12, thereby shortening the distance from L1 to L2 and substantially preventing interference with deployment of the airbag. The force applied to the first arm 116 by the deploying airbag is sufficient to pivot the projection 116E out of engagement with the first notch 144C and to laterally move the first arm 116 against the first spring member 146 such that the projection engages the third notch 144D and shortens the length from L1 to L2, thereby substantially preventing interference with deployment of the airbag.

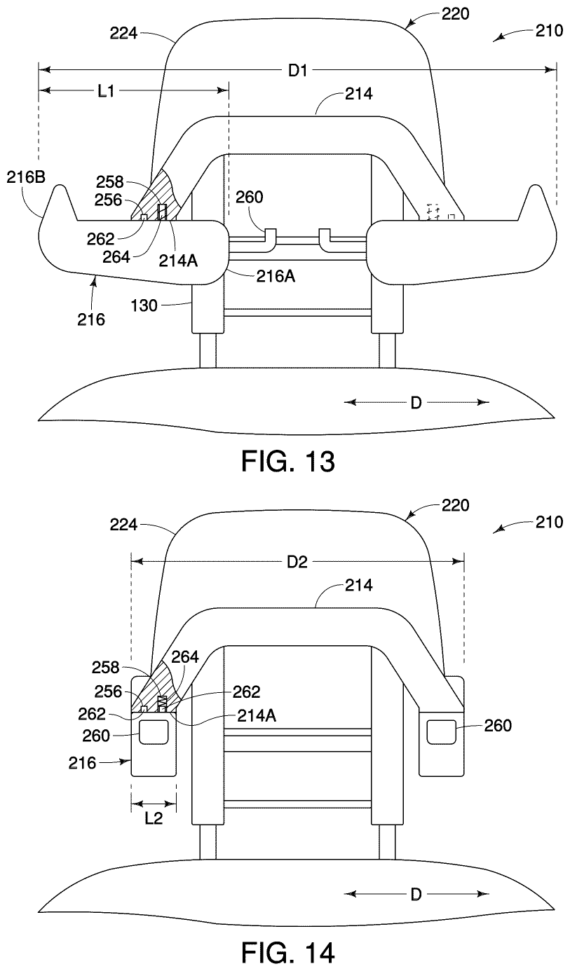

Another exemplary embodiment of the vehicle hanger assembly 210 is shown in FIGS. 13-16. The features of the vehicle hanger assembly 210 of FIGS. 13-16 that are substantially similar to the features of the vehicle hanger assembly 10 of FIGS. 1-10 are provided the same reference numerals as the features of the vehicle hanger assembly 10 except in the 200 series (i.e., 2xx). Moreover, the descriptions of the parts of the vehicle hanger assembly 210 of FIGS. 13-16 that are identical to the vehicle hanger assembly 10 of FIGS. 1-10 are omitted for the sake of brevity.

The vehicle hanger assembly 210, as shown in FIGS. 13-16, includes a main body 214 and an arm 216. The main body 214 is configured to be removably connected to a headrest 224 of a seat 220. The arm 216 is movably connected to the main body 214. The arm 216 is configured to move relative to the main body 14 to reduce a length of the vehicle hanger assembly 10 in a lateral direction D of a vehicle 12.

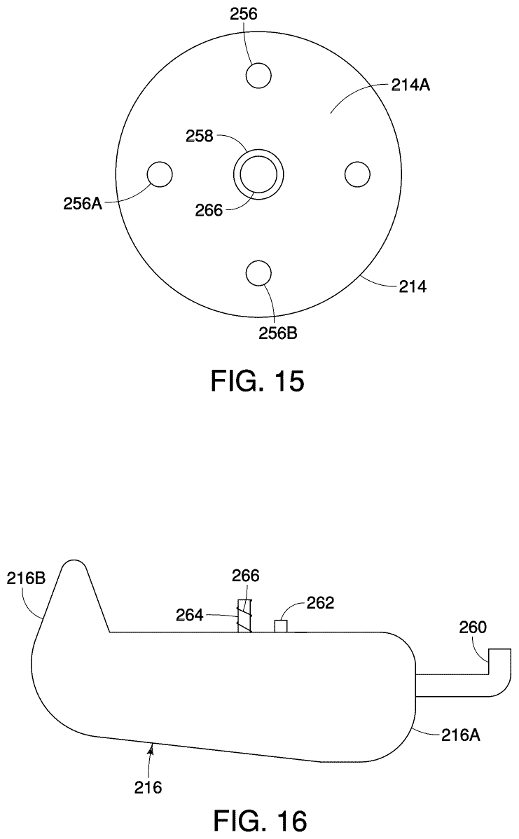

An end surface 214A of the main body 214 includes a plurality of detents 256 disposed proximate to an outer periphery 214B of the end surface 214A, as shown in FIG. 15. The end surface 214A can have any suitable number of detents 256, although four detents are shown in FIG. 15. Each of the four detents 256 is equally space from adjacent detents in the circumferential direction. As shown in FIG. 15, each detent 256 is spaced from adjacent detents 256 by approximately 90 degrees in the circumferential direction. The end surface 214A is illustrated as being substantially horizontally disposed, although the end surface 214A can have any suitable orientation, such as being vertically disposed. A fastener opening 258 is preferably centered in the end surface 214A, although the fastener opening can be disposed in any suitable location.

The arm 216 extends from a first end 216A to a second end 216B, as shown in FIGS. 13, 14 and 16. A hook 260 extends outwardly from the first end 216A of the arm 216. The hook 260 is rigidly connected to the arm 216 in any suitable manner. The hook 260 allows a bag or other object to be hung from the hook 260.

A first projection 262 extends upwardly from the arm 216 and is configured to be received by one of the plurality of detents 256 in the end surface 214A of the main body 214.

A second projection 264 extends upwardly from the arm 216 and is configured to be received by the fastener opening 258 in the end surface 214A, as shown in FIGS. 13, 14 and 16. The second projection 264 extends from the arm 216 further than the first projection 262 in a direction substantially perpendicular to the surface of the arm 216.

A spring member 266 extends along the second projection 264 from the upper surface of the arm 216 to an inner surface of the fastener opening 258 in the end surface 214A of the main body 214. The spring member 266 biases the arm 216 toward the end surface 214A of the main body 214. The arm 216 is movable in a direction away from the end surface 214A to disengage the first projection 262 from one of the detents 256. The engagement between the second projection 264 of the arm 216 and the fastener opening 258 in the end surface allows the arm 216 to rotate relative to the end surface 214A of the main body 214. The spring member 266 draws the second projection 262 into another one of the plurality of detents 256 when the arm 216 is disposed in a desired position.

As shown in FIGS. 13 and 15, the arm 216 is disposed in a first detent 256A, or the outboard-most detent, of the plurality of detents 256. In other words, as shown in FIGS. 13 and 15, the arm 216 is disposed in a first position. When the first projection 262 of the arm 216 is disposed in the first detent 256A, the length L1 is a maximum distance from an outboard-most end of the arm 216 to the end of the hook 260 in the lateral direction D of the vehicle.

Applying a downward force F to the arm 216 disengages the first projection 262 from the first detent 256A while maintaining engagement between the second projection 264 and the fastener opening 258. The arm 216 can then be rotated about the second projection 264 relative to the end surface 214A of the main body 214. As shown in FIG. 14, the first arm 216 is rotated to a second detent 256B. In other words, as shown in FIG. 14, the arm 216 is disposed in a second position. When the first projection 262 of the arm 216 is disposed in the second detent 256B, the length L2 is a minimum distance from an outboard-most side 216 of the arm 216 to an inboard-most side 216 of the arm 216. The distance L2 is less than the distance L1. As shown in FIGS. 13 and 14, the arm 216 is rotated approximately 90 degrees from the first position shown in FIG. 13 to the second position shown in FIG. 14. When the force applied to the arm 216 is released, a spring member contracts to engage the first projection 262 with the second detent 256B, thereby securely retaining the first arm 216 in the second position. The arm 216 can be moved to any detent 256.

In the first position shown in FIG. 13, the arm 216 is configured to extend in the lateral direction D of the vehicle when the first projection 262 is received by the first detent 256A. In the second position shown in FIG. 14, the arm 216 is configured to extend in the longitudinal direction of the vehicle when the first projection 262 is received by the second detent 256B. The longitudinal direction of the vehicle is substantially perpendicular to the lateral direction of the vehicle. The longitudinal direction extends in a front to rear direction of the vehicle. The arm 216 is configured to be moved from the first position shown in FIG. 13 in which the arm 216 is configured to extend in the lateral direction D of the vehicle to the second position shown in FIG. 14 in which the arm 216 is configured to extend in the longitudinal direction of the vehicle. In the second position shown in FIG. 14, the hook 260 extends in the longitudinal direction away from the headrest 224 to provide easier access to the hook 260.

When the downward force F applied to the arm 216 is from an object, such as a deploying airbag, the spring member causes the first projection 262 to move from the first detent 256A to the second detent 256B, as shown in FIGS. 13-15, thereby shortening the distance from L1 to L2 and substantially preventing interference with deployment of the airbag. The force applied to the arm 216 by the deploying airbag is sufficient to overcome the spring member and move the first projection 262 out of engagement with the first detent 256A and to rotate the arm 216 such that the first projection engages the second notch 256B and shortens the length from L1 to L2, thereby substantially preventing interference with deployment of the airbag.

In another exemplary embodiment, the arm is frangibly connected to the main body. When an object, such as a deploying airbag, contacts the arm 16 with sufficient force, the arm is separated from the main body at the frangible portion of the first arm. Severing the arm from the main body shortens the length of the hanger assembly, thereby preventing interference with an object, such as a deploying airbag.

In another exemplary embodiment, a hook can be movably connected to the main body. The hook can be disposed in a first position in which the hook is received within the main body. The hook can be moved to a second position in which the hook extends outwardly from the main body. The hook allows the hanger assembly to be hung from a rod, hook, or other structure when removed from the vehicle.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle hanger assembly. Accordingly, these terms, as utilized to describe the present invention should be interpreted relative to a vehicle equipped with the vehicle hanger assembly.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle hanger assembly comprising:
a main body configured to be connected to a headrest; and
an arm movably connected to the main body,
the arm being configured to move relative to the main body to reduce a length of the vehicle hanger assembly in a lateral direction of a vehicle.

2. The vehicle hanger assembly according to claim 1, wherein
the arm is configured to move in the lateral direction of the vehicle.

3. The vehicle hanger assembly according to claim 2, wherein
the main body includes a chamber configured to movably receive the arm.

4. The vehicle hanger assembly according to claim 3, wherein
a first spring member is disposed between a first end of the arm and a first end of the chamber.

5. The vehicle hanger assembly according to claim 4, wherein
an opening is disposed in a second end of the chamber, the arm extending through the opening such that a second end of the arm is disposed externally of the chamber.

6. The vehicle hanger assembly according to claim 4, wherein
a plurality of notches are disposed in a lower surface of the chamber, the arm being configured to engage one of the plurality of notches.

7. The vehicle hanger assembly according to claim 6, wherein
a locking member is movably received by the arm, the locking member preventing the arm from disengaging the one of the plurality of notches.

8. The vehicle hanger assembly according to claim 7, wherein
the locking member includes a second spring member and a ball, the second spring member biasing the locking member toward an upper surface of the chamber.

9. The vehicle hanger assembly according to claim 8, wherein
downward movement of the second end of the arm compresses the second spring to allow lateral movement of the arm to another one of the plurality of notches.

10. The vehicle hanger assembly according to claim 4, wherein
the first spring member is disposed above an upper surface of the arm.

11. The vehicle hanger assembly according to claim 7, wherein
the locking member is a ball received in a groove of the arm.

12. The vehicle hanger assembly according to claim 11, wherein
a diameter of the ball is larger than a length of the groove in the lateral direction.

13. The vehicle hanger assembly according to claim 1, wherein
a projection extends outwardly from the arm, the projection being received by one of a plurality of detents disposed in the main body.

14. The vehicle hanger assembly according to claim 13, wherein
the arm is configured to rotate to move from a first detent of the plurality of detents to a second detent of the plurality of detents.

15. The vehicle hanger assembly according to claim 14, wherein
the arm rotates approximately ninety degrees from the first detent to the second detent.

16. The vehicle hanger assembly according to claim 13, wherein
the arm is configured to extend in the lateral direction of the vehicle when the projection is received by the first detent.

17. The vehicle hanger assembly according to claim 16, wherein
the arm is configured to extend in a longitudinal direction of the vehicle when the projection is received by the second detent.

18. The vehicle hanger assembly according to claim 13, wherein
a hook extends outwardly from an end of the arm.

19. The vehicle hanger assembly according to claim 18, wherein
the arm is moved from a first position in which the arm is configured to extend in the lateral direction of the vehicle to a second position in which the arm is configured to extend in a longitudinal direction of the vehicle to provide access to the hook.

20. The vehicle hanger assembly according to claim 1, wherein
the main body is configured to be removably connected to the headrest.

21. The vehicle hanger assembly according to claim 4, wherein
the first spring member is configured to bias the arm to an extended position.
